(19) United States
(12) Patent Application Publication
(10) Pub. No.: US 2010/0115951 A1
(43) Pub. Date: May 13, 2010

(54) Design of a group of wind power plants

(75) Inventor: Bernt Ebbe Pedersen, Kolding (DK)

Correspondence Address: Mollborn Patents, Inc., 2840 Colby Drive, Boulder, CO, 80305, US

(73) Assignee: LM GLASFIBER A/S, Kolding (DK)

(21) Appl. No.: 12/597,855

(22) PCT Filed: Apr. 22, 2008
(86) PCT No.: PCT/DK08/00146

§ 371 Date: Nov. 13, 2009

(30) Foreign Application Priority Data
Apr. 27, 2007 (DK) PA 2007/00630

(51) Int. Cl. F03D 9/00

(52) U.S. Cl. 60/698; 416/223 R; 703/7

(57) ABSTRACT

The present invention relates to a group of wind power plants for positioning in approximately the same wind climate, comprising at least a first and at least a second wind power plant, where the first wind power plant exhibits maximised power output within a first interval of wind speeds, and the second wind power plant is designed to exhibit maximised power output within a second interval of wind speeds which is different from and starting from lower wind speeds than the first wind speed interval to the effect that the total power output of the group of wind power plants is increased at lower wind speeds. Moreover, the invention relates to a method of designing a group of wind power plants in accordance with the above. This can be accomplished eg by designing the supplementary wind power plant(s) with a larger rotor area and with a lower cut-out wind speed or, alternatively, by using a wind power plant without power-regulating means. Hereby it is accomplished that the power production of the group becomes more uniform and not so dependent on the current wind speed. The smaller power output from the supplementary wind power plants is completely or partially balanced by, on the one hand, the lower production and operating costs of the turbine and, on the other, the higher price on electricity.

The invention relates to a group of wind power plants for being positioned in approximately the same wind climate comprising at least a first and at least a second wind power plant.

### BACKGROUND

An energy network that regulates and provides services to the energy supply of a region is described in general by its local energy sources such as eg coal-fired, hydro-, nuclear power plants, wind power farms, its consumers and the associated transmission capacities, both internally in the network and in and out of the network for importation and exportation of power. Conventionally, the various energy networks are bound to countries, regions or areas of land, but often they are also defined by geographical and purely practical conditions. One example of such geographically delimited power network is western Denmark which is currently electrically connected to Norway, Sweden, and Germany. The overall transmission capacity to Norway constitutes 1040 MW, while the overall capacity to Sweden constitutes 740 MW. Finally, there are the connections to Germany that have an overall capacity in the southbound direction (ie exportation from western Denmark) of about 1250 MW. The overall transmission capacity out of western Denmark thereby constitutes about 3000 MW. Besides, a 600 MW connection under the Great Belt is planned.

As time goes by, the connections (both the purely physical transmission cables and the political and financial cooperation) between the individual regions become increasingly improved to the effect that the individual areas and power networks are increasingly interrelated with ensuing advantages and drawbacks of such interrelation. Thus, a well upgraded transmission network is essential for ensuring a stable energy supply with good options for both importation and exportation, depending on what can be advantageous both with respect to price and production, in particular in the context of electricity since current cannot readily be stored. Conversely, closely connected networks can also be problematic, for instance a sudden local failure in eg Holland may, in a worst-case scenario, also entail power cuts in the major part of Europe as a whole. The control and regulation of the individual power networks are therefore of the utmost importance. In the majority of cases, it is therefore a priority to power networks to strike a balance between energy generation and consumption to avoid operating failures both in the form of potential power cuts in case of too low production and to avoid electricity spill-over in case of excess production which may ultimately lead to complete failure of the power network. The energy generation in the power network is therefore continuously upscaled and downscaled to the extent possible in pace with prognoses on consumption and expectations for importation and exportation.

In 2006, the installed wind turbine power in western Denmark constitutes about 2400 MW and thus constitutes a considerable part of the energy production. The replacement of old wind turbines with more recent and larger turbines is furthermore expected to contribute with further 175 MW by the end of 2009. Moreover, the sea-based wind farm Horns Rev 2 is to be put into operation in 2009, which adds further 200 MW. Finally, based on a national Danish energy plan and for the EU, a considerably more intense growth is expected which presumably entails a doubling of the installed wind turbine power output capacity within the next approximately 15 years, not merely in western Denmark, but also in Europe. It is generally desired in many places to increase the wind power output based on the views that wind power is a sustaining and environmentally friendly source of energy which is omnipresent and hence able to contribute to making, to a higher degree, the energy supply of each individual region independent of any import of oil, coal, and gas. Where, earlier on, the wind power was produced by singular or a small number of individual interconnected wind power plants, now, most often large groups of wind power plants are positioned or even decided wind farms that can be coupled directly to the power network. New wind power plants and groups of wind power plants are conventionally designed to yield the largest possible annual power output, and, in recent years, development has moved towards increasingly larger wind power plants with longer blades, more sophisticated power control and larger power output.

However, a fairly significant drawback of wind power is that the production is directly conditioned by and varies considerably with the current wind and weather conditions. Therefore, it is necessary that the wind power generation is a supplement to conventional sources of energy whose power outputs are consequently to a certain extent to be upscaled and downscaled correspondingly in pace with the produced amount of wind power, expected consumption and prognoses of same, eg based on weather forecasts. However, it is a both complex and resource-intensive process to up- and down-scale the power output of the power plants, which takes both comparatively long time (several hours) and causes undue wear on the installations of the power plants. This is a problem in particular in the context of coal-fired and nuclear power plants.

A further problem in the context of utilising wind power is the fact that most wind turbines are stopped when a given cut-out wind speed is reached to prevent overload of the wind turbine in powerful storms. That wind speed, which is a compromise between the desire to protect the wind turbine and the desire to obtain maximal power output, has so far been selected merely in consideration of the overall annual output of the wind turbine. Based on this, the vast majority of the wind turbines available on the market today have a cut-out wind speed of 25 m/s. However, this entails great problems with the power supply to a power network when the wind gets above 25 m/s, since, in that event, a large part of the turbines and hence a large output is suddenly cut out within a very short period of time (a few hours) and without warning.

The problem is that it is very difficult to predict whether the wind will exceed the cut-out wind speed, so it is impossible to know whether it will become necessary to increase the output on the conventional power plants. When the wind power production is expanded, this problem is expected to increase further.

A further problem of expanding the wind power generation in a power network is that the power output will be considerably increased in case of the elevated wind speeds, where all the wind power plants (however with minor regional differences) will produce maximally independently of the current consumption and need as such or options for exportation. Thus the power network must be dimensioned to be able to handle and cope with such peak loads to avoid power failures, which requires is large transmission capacity. An expansion of the wind power capacity in Denmark as expected, where the overall transmission capacity out of western Denmark constitutes, as mentioned, about 3000 MW or just slightly more than the overall installed wind turbine power output today, will thus necessitate an investment in the range of DKK 12 billion for larger or newer transmission lines to enable sufficient exportation. An alternative to this is to control the power output of each individual wind farm such that it does not exceed a certain maximum value—either by gradual reduction of the power generation of each wind power plant or by completely stopping individual turbines in the wind farm, as described eg in U.S. Pat. No. 6,724,097 (Wobben). The drawbacks of this strategy is, on the one hand, that it necessitates a complex control of each group of wind power plants and, on the other, that one misses out on a considerable amount of power.

Another relevant aspect of significance to the expansion of the wind power output is the price on power which is, in the Nordic countries, determined on the Nordic electricity exchange. There the price on power is set 24 times per calendar day, on the day before the working calendar day, based on supply and demand on the overall market (the system price). Owing to limitations in the transmission capacity and the fact that current cannot readily be stored, the so-called regional price is determined in the individual regions which depends on supply and demand in the individual region and, of course, on the transmission options. In areas where wind turbines cover a considerable part of the electricity consumption, the area price will be influenced by the wind speed, since increasing wind speed entails a dramatically increasing supply of electricity. For instance, the regional price in Jutland is sometimes as low as DKK 0.01/kWh on windy nights. This type of region is expected to become more widespread in the future in pace with increasing expansion of the wind power capacity and optionally increasing liberalisation of the electricity markets. An expansion of the installed wind power capacity alone can thus be expected to enhance the above-described tendency to the effect that the earning capacity of a wind power plant is deteriorated.

### OBJECT AND DESCRIPTION OF THE INVENTION

It is the object of the invention to provide methods of designing and controlling power networks and groups of wind power plants such that the above problems associated with expansion of the wind power production are reduced or completely obviated.

Thus, the present invention relates to a group of wind power plants for being positioned in approximately the same wind climate comprising at least a first and at least a second wind power plant, wherein the first wind power plant exhibits maximised power output within a first interval of wind speeds; and the second wind power plant is designed to exhibit maximised power output within a second interval of wind speeds which is different from and starting from lower wind speeds than the first wind speed interval to the effect that the total power output for the group of wind power plants is increased in case of lower wind speeds. Here and throughout this application, a group of wind power plants is to be understood as two or more wind power plants coupled to the same power network. When a wind power plant is positioned or modernised, it is conventionally done such that the annual power output of the turbine is maximised to the wind climate (ie annual wind conditions, temperatures and pressure conditions) where the turbine is to be positioned and, of course, within the framework of practicability and economy, etc. By the present invention, a wind power plant is instead designed and constructed as described above to fit into and supplement the other wind power plants in the group. When the desired power curve of a wind power plant (power production as a function of wind speed) is selected and fixed, a person skilled in the art will know how the construction of the wind power plant is to be made. It can be accomplished eg by increasing the rotor area (longer blades, less coning, etc.) or by increasing the solidity of the rotor (ie how large the area of the blade is to be relative to the area of the entire rotor disc), optionally in combination with a lower cut-out wind speed.

By a group of wind power plants in accordance with the above, improved utilisation of wind power and a more uniform power output is accomplished in all wind conditions, which is advantageous, on the one hand, from a socio-economical point of view and, on the other, since it is hereby possible to avoid or reduce the need for advanced control and regulating mechanisms on the power network and on the individual wind power plants or wind farms. Thus, the need for upscaling and downscaling conventional power plants, which are both inefficient and wearing procedures, is considerably reduced. A further advantage is that the risk of having to cut out wind farms due to excess production is avoided or at least reduced. Likewise, the utilisation of wind power can be extended considerably without an ensuing need for investments in expansion of the transmission capacity, on the one hand from the individual groups of wind power plants and, on the other, from the individual energy networks. The reduced power output from the supplementary wind power plants is balanced completely or partially by the lower production and operating costs of the turbine and also by the increased price on the electric power. The invention is also advantageous in that it can be implemented in a simple manner, eg by “upgrading” individual or some of the existing wind power plants in a group with larger rotors, other blades, etc. Thus, the new rotor could optionally be designed to be readily mountable on a conventional wind power plant designed in accordance with conventional principles and with a smaller rotor.

According to one embodiment of the invention, this or the other wind power plants of the group has/have a lower cut-out wind speed than the first wind power plant. Hereby the advantageous aspect is accomplished that the maximal loads on the wind power plant that occur at the highest wind speeds are reduced correspondingly. This may then optionally be used to advantage to further increase the power production at lower wind speeds. Likewise, a lower cut-out wind speed also entails that the longevity of the wind power plant is increased considerably. Albeit, by designing the wind power plant in particular for a cut-out wind speed which is low, one will considerably reduce the annual output of the individual wind power plant, but the value of the annual output will, with a high degree of probability, remain unchanged or even increase due to the power being gained at lower wind speeds having a generally much better selling price than the power which is lost in case of the higher wind speeds. Add to this the technical advantages mentioned above.

According to one embodiment of the invention, the second wind power plant has a larger rotor area and/or higher degree of solidity than the first wind power plant in the group. Hereby the increased power output compared to the lower wind speeds that can be produced by the existing production equipment is accomplished in a simple manner.

According to a further embodiment the second wind power plant is characterised by not comprising power regulating means. In a conventional mindset this is unthinkable, since, in that case, the turbine is completely unable to tolerate the loads in case of high wind speeds. According to the present invention such turbine as a part of a group is advantageous, however, considering the view of an overall increased power output for the entire group in case of lower wind speeds. Instead of regulating the power output, the other wind power plant is simply stopped. Such wind power plant for the group is advantageous since, in that case, the wind power plant may be manufactured at considerably less expense and more lightly and with fewer requirements to maintenance and repair. The lighter construction may then in turn by utilised eg for allowing a further increase in the rotor area and hence in the power output.

One embodiment of the invention relates to a group of wind power plants according to the above, where the second wind power plant has a lower rated wind speed than the first wind power plant.

The present invention also relates to a method of designing a group of wind power plants for being positioned in approximately the same wind climate, comprising at least a first and at least a second wind power plant, wherein the first wind power plant exhibits maximised power output within a first interval of wind speeds, and wherein the second wind power plant is designed to exhibit maximised power output within a second interval of wind speeds which is different from and starting from lower wind speeds than the first wind speed interval to the effect that the overall power output for the group of wind power plants is increased in case of lower wind speeds. The advantages of this are as described above.

According to one embodiment of the method, the second wind power plant is designed to exhibit maximised power output within a second interval of wind speeds to the effect that the value of the overall power output for the group of wind power plants is maximised.

According to further embodiments of the method, the second wind power plant is designed by choice of blade length and/or solidity.

According to further embodiments of the method, the desired power output of the second wind power plant is determined on the basis of the transmission capacity of the group and/or the price on power.

The present invention further relates to a wind power plant of the front-runner type and the fast-runner type without power-regulating means. This is advantageous in that it is hereby possible, in a simple manner, to obtain a wind power plant that supplements the other wind turbines of conventional types. Instead of performing the usual power regulation in case of high wind speeds, the wind power plant is merely stopped, and then the turbine may instead be designed for a considerably higher power output in case of the lower wind speeds. The overall power output from a group of wind power plants of different types hereby becomes high across a larger interval of wind speeds with the advantages already set forth above.

In embodiments of this, the wind power plant according to the above is without active stall regulation, without passive stall regulation and/or without pitch regulation.

Finally, the invention also relates to a group of wind power plants comprising one or more wind power plants as described above.

### BRIEF DESCRIPTION OF THE DRAWINGS

In the following, the invention will be described with reference to the figures, in which:

FIG. 1 shows a typical power curve for a wind power plant,

FIG. 2 illustrates the overall power output for a group of wind power plants;

FIG. 3 shows a group of wind power plants coupled to an energy supply network;

FIG. 4 illustrates power curves for a composition of wind power plants according to the invention;

FIG. 5 shows the regional price for electricity power plotted as a function of the amount of electricity produced by wind for western Denmark in 2006; and

FIG. 6 schematically shows other types of power curves for wind power plants.

### DESCRIPTION OF EMBODIMENTS t

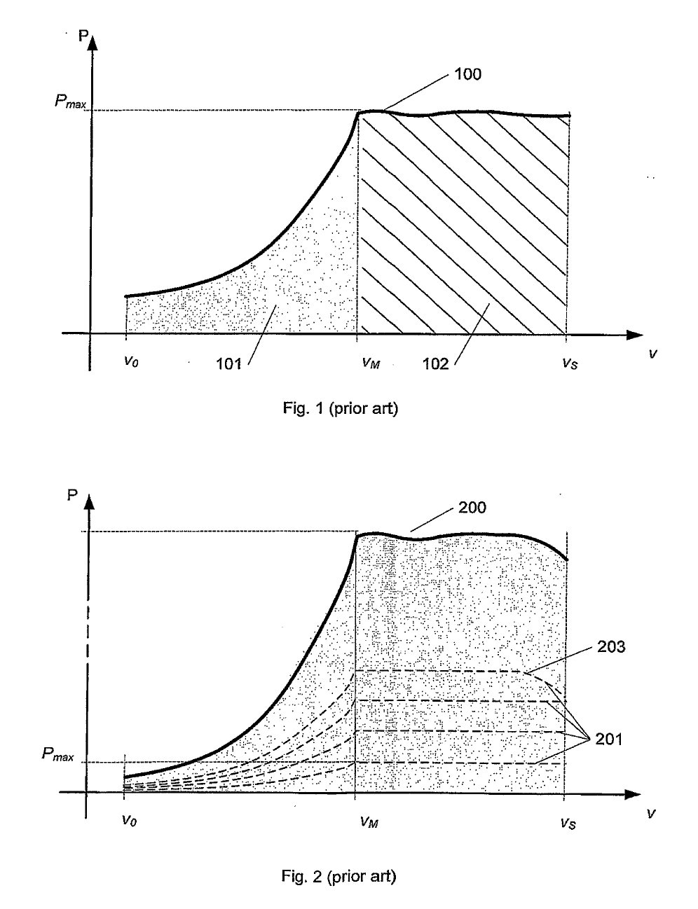

FIG. 1 schematically shows a typical power curve 100 for a wind power plant. The curve shows the power produced P or the power output as a function of the wind speed v. The wind power plant starts to produce power at a starting wind at the speed V₀ which is most often of the magnitude of 2-4 m/s. Here pitch-regulated wind power plants may pitch the blades slightly and help the wind power plant start up. From then on, the power output increases with increasing wind speeds until the rated wind speed V_{M} where the wind power plant yields the maximal effect Pₘₐₓ, also called the rated power. In that area 101, the wind power plant is constructed for maximising the power output and productivity of the wind power plant and utilise the energy of the wind optimally. The energy content of the wind increases by the wind speed raised to the third power, but how much of that energy the wind energy plant is able to exploit from a purely physical point of view and from a point of view of design will depend on the construction of the various parts of the wind power plant.

In general a wind power plant is designed to yield a maximal annual power output. The magnitude of the rated wind speed V_{M} is therefore primarily set to match the local wind conditions and the mean wind speed where the wind power plant is to be positioned and is typically of the magnitude 12-16 m/s. Moreover, other factors such as the size of the generator are of significance to the absolutely precise magnitude of the rated wind speed.

From that rated wind speed V_{M} and until the cut-out wind speed V_{S} (also designated the stop or cut-off speed) where the rotor is stopped, the wind power plant is constructed to yield an approximately constant maximal power Pₘₐₓ, which is obtained by power regulation. The power uptake at different wind speeds can be regulated by means of the blades in accordance with three different methods that will be discussed briefly in the following:

In the same way as an airplane may lose lift and begin to stall, a blade may be turned to the effect that it loses lift and the output of the rotor is reduced. In case of passive stall-regulated turbines, each blade is fixedly mounted on the hub in a specific angle of attack. The blade is constructed such that turbulence is generated on the rear side in case of forceful winds. That stall stops the lift of the blade. The more powerful the wind, the more heavy turbulence and hence braking effect, whereby the turbine output is regulated. Active stall-regulated wind turbines turn the rear edge of the blade upwards into the wind by a few degrees (negative pitch angle) when they regulate the effect. It takes place by the entire blade being turned (pitched) about its own axis—most often by means of a hydraulic system. The majority of rotors on recent and larger wind power plants are pitch-regulated. Here the power output is regulated in accordance with the wind conditions by the fore edge of the blade being turned into the wind (positive pitch angle), as opposed to the aforementioned active stall-regulated turbines that turn the rear edge of the blade up into the wind. Apart from power regulation by means of the blades, which is far the most commonly used one, a wind power plant may also be power-regulated eg by gradually pitching the rotor out of the wind.

The additional power that could actually be extracted in case of such elevated wind speeds between the rated wind speed V_{M} and the cut-out wind V_{S} is usually not utilised, since it is not profitable compared, on the on hand, to the frequency of such high wind speeds occurring and, on the other, the additional production costs entailed by the correspondingly larger wind loads in the form of requirements to stronger gears, tower, generator, etc. In that interval 102, at speeds between V_{M} and V_{S}, the wind power plant is thus usually constructed to minimize the loads on the wind power plant. Likewise, the wind power plant with relatively flexible blades is often dimensioned such that the blades are not to deform and flex to such extent that they may hit the tower (deformation dimensioned), which is an essential parameter precisely in the area 102 at high wind speeds. In forceful storms at cut-out wind speed V_{S}, the wind power plant is stopped to prevent overload or, in a worst-case scenario, destruction. That cut-out wind speed is a compromise and a weighing of the desire to spare the turbine and the desire for maximal energy production, and is conventionally determined exclusively with regard to the total annual output of the wind turbine. Based on this, and for historical reasons, almost all wind power plants on the market today have a standard cut-out wind speed of Vs=25 m/s.

FIG. 2 illustrates the total power output 200 for a group of wind power plants that is the result of the sum of the power curves 201 from the individual wind power plants in the group (of which only a few are shown in the figure, for the sake of clarity). Conventionally, a group of wind power plants or a wind farm consists of a number of identical wind turbines, each of which is designed to maximize the annual power output and thus also to maximise the power output of the group in the given wind climate in which the turbines are positioned. However, there may be variations between the power curves 201 deriving eg from the positions of the individual wind power plants in each other's slipstreams at specific wind directions, different setting of the rotor tilt, etc. Moreover, some of the wind power plants may also be regulated differently from the others to eg stop if the overall power production exceeds a certain maximum or if eg the power supply network asks the wind farm to supply less power to the energy network. This is shown in the figure by the power curve 203 and is reflected in the total power curve 200 for the entire group of wind power plants.

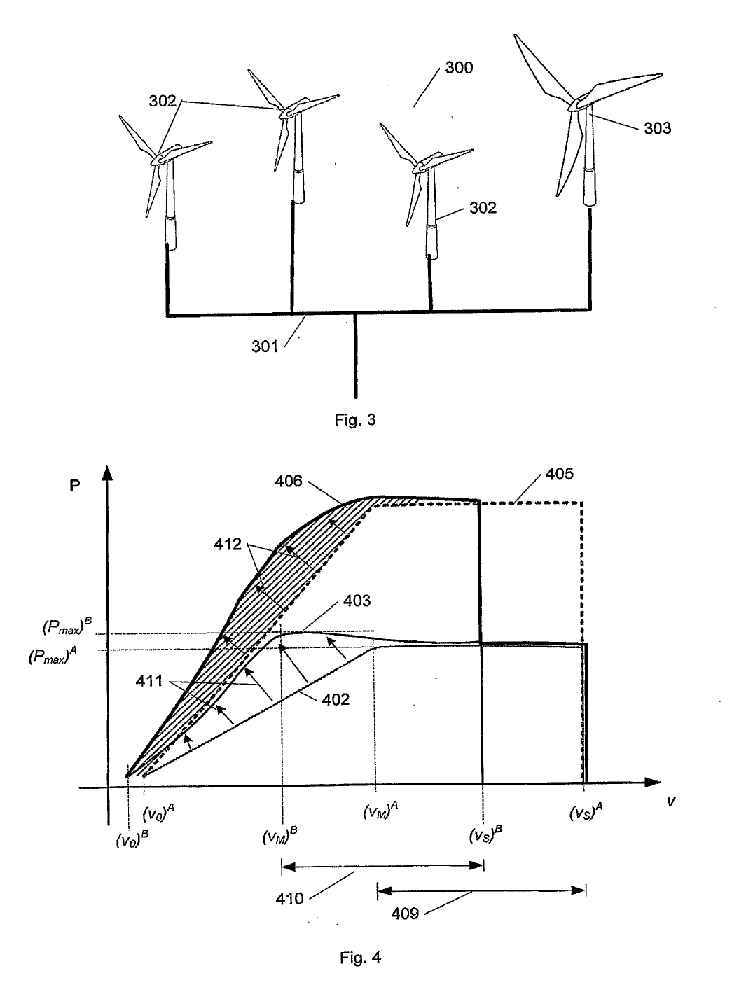

As will appear from the total power curve 200 in FIG. 2, the exploitation of wind power is conditioned by and strongly depends on the current wind speed. As mentioned in the introductory part, this causes a fair amount of problems to the utilisation of the wind energy and to the power network to which the wind power plants are coupled. This is solved or at least remedied in accordance with an embodiment of the present invention by designing groups of wind power plants such that they comprise wind power plants designed and optimised to give maximal power output at different windows or intervals within the wind spectre, albeit each individual turbine is to operate in the same or approximately the same wind climate. I popular terms, some of the turbines are thus designed and constructed to be non-optimal, seen singularly (from a power output point of view), in order to thereby give a more even output seen for the entire group. A surprising aspect by this is that it is also advantageous for other reasons, on the one hand for financial and, on the other, for technical reasons on the individual turbine. This will be elaborated on in the following. The idea is shown in FIG. 3 which shows a part of a group of wind power plants or a wind farm 300 coupled to the same energy network 301. A group of wind energy plants is here to be understood, as also mentioned above and throughout the application, as two or more wind power plants coupled to the same energy network. The turbines 302 (the exact number of which is not essential to the principle of the invention) are conventional turbines designed and constructed such that their annual power output is maximised to the given wind climate in which they are positioned and with power curves 201, 402 of the same common type as shown in previous FIG. 2 and FIG. 4. In accordance with the invention, those wind power plants are supplemented by one or more wind power plants 303 which, opposed to the remaining ones are not designed for maximal annual power output in the wind climate in which they are positioned. Conversely, they are designed and constructed to supplement the remaining wind power plants 302 by having maximal power output at other, lower windows or intervals 410 of the wind speed spectre. Hereby the total power output for the entire group of wind power plants positioned in the same wind climate is maximised across a larger interval of wind speeds, and the total power curve 406 reaches the maximal power output in case of lower wind speeds compared to a scenario in which all of the turbines had been of the same type.

This is shown in FIG. 4 where a power curve 402 for a conventional wind power plant 302 is shown with a rated wind speed (V_{M})^{A} and power regulation until the cut-out wind speed (V_{S})^{A} as described above. Moreover, a dotted line shows the total power curve 405 for two such wind energy plants of the same conventional type 302 and likewise a total power curve 406 for two wind power plants 302, 303 of different types and designed in accordance with different principles as described in accordance with the invention. The latter total power curve 406 is produced as the sum of a conventional power curve 402 and the power curve 403 that gives maximal power output from lower wind speeds (V_{M})^{B} than the other turbines in the group as illustrated by the arrows 411. This other type of wind power plant 303 is, as mentioned, designed and constructed to yield a maximised power output in case of lower wind speeds and thus yields the highest maximal power (Pₘₐₓ) or rated power in another window or interval 410 of the wind spectre than the first wind power plant 302 in the group 409. Hereby also the total power output of the group 406 is correspondingly increased at the lower wind speeds in the wind spectre. The resulting change in the total power output which is achieved by such inhomogeneous and different composition of a group of wind power plants is illustrated in the same manner by arrows 412 and by the hatched area in the figure.

For the sake of clarity, only the power curves for a group of two wind power plants are outlined in the figure, but the same principle as described applies to larger groups comprising several turbines of each type or comprising more different types than precisely two. Correspondingly, the outlined power curve 403 for the supplementing wind power plant in the group was drawn for illustration to show the principle of the invention and, consequently, it is not the only option for providing the desired power with a particularly increased overall power output at lower wind speeds in the wind spectre. Other possible power curves are shown in the following figures.

In the embodiment shown in FIG. 4, the wind power plant of the second type 303 has a lower rated wind speed (V_{M})^{B} and cut-out wind speed (V_{S})^{B} than conventional (V_{M})^{A}, (V_{S})^{A}. The reduction in the cut-out wind speed is essential as this is precisely what enables the increased power output at the lower wind speeds. A wind power plant can be designed for such power curve 403 with ensuing improved utilisation of the power of the wind at the lower wind speeds by customising the rotor and the size thereof. For instance, the blades can be made longer thereby increasing the rotor area, the solidity (the portion of the rotor area covered by the blades) can be increased eg by increasing the width of the blades, or the design of the blade profiles can be changed. However, such changes in design parameters also entail heavily increased loads on the wind power plant, and it follows that the cut-out wind speed (V_{S})^{B} is therefore to be reduced simultaneously in order for the turbine not to break down at higher wind speeds.

Apart from the added production at the lower wind speeds, a wind power plant designed as described above may also conceivably be able to start up and begin to produce energy at lower wind speeds (V₀)^{B} as also shown in the figure.

Such way of composing wind power plants, in accordance with the above, is advantageous by resulting in an improved utilisation of the wind energy across a wider spectre of wind speeds. This is advantageous, on the one hand based on a socio-economical perspective since the wind energy may then be used to advantage more of the time, but also just as much in connection with the construction, control and regulation of energy networks where the otherwise very uneven utilisation of wind gives rise to quite a number of problems as mentioned in the introduction. As will appear from FIG. 4, the total power output for a group of wind energy plants will, however, also be smaller in case of the highest wind speeds compared to a scenario in which only wind turbines of the same type had been used and where all had the same cut-out wind speed. However, from an overall point of view, this is not a problem since, most often, more current than necessary will still be produced at those high wind speeds. Conversely, it may be advantageous, since the need for down-scaling the power output of a wind farm and the control thereof, which is a complex as well as price-raising element, can be obviated.

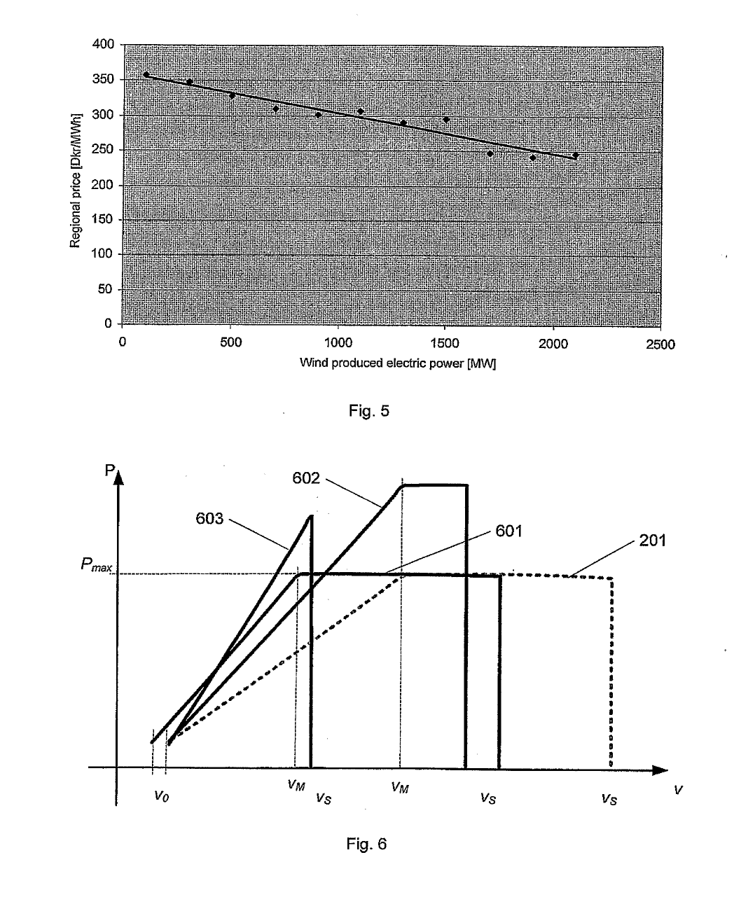

Yet a considerable advantage of the described way of supplementing or composing groups of wind power plants becomes clear when the price of electricity is taken into consideration. As also mentioned in the introduction, the price on electricity and what a producer able to sell his energy at is regulated continuously in accordance with supply and demand and how large the transmission capacities are for the energy network. Therefore, the area price on electricity is also seen to depend directly on the amount of electricity produced by wind as shown in FIG. 5 for western Denmark for 2006. With the existing wind power plants that are dimensioned and constructed for maximal annual power output, this consequently means that the price on electricity is markedly higher in case of low wind speeds and decreases with increasing wind speeds. By composing groups of wind power plants in accordance with the invention, a relatively large reduction in the total annual production is thus obtained, but the value of the annual production is increased due to the current gained in case of low wind speeds has a far better selling price than the current lost in case of the higher wind speeds. This is illustrated by the following examples.

In case of a mean wind speed of eg 9 ms corresponding largely to Horns Rev off the Jutlandic west coast, the expected annual production is about 21.3 GWh within the wind speed interval of from 4 to 25 m/s for a 5 MW wind turbine with a rotor diameter of 126 m corresponding to the largest wind turbines on the market today. If a cut-out speed of 16 m/s is selected instead, the annual production is 16.5 GWh corresponding to a loss of energy output of 22.5%,

With starting point in a 5 MW wind turbine with a rotor diameter of 126 m corresponding to the largest wind turbines on the market today, estimative calculations are made of the expected annual energy output in case of different wind speeds and in areas with different mean wind speed. In case of a mean wind of eg 9 m/s, corresponding largely to Horns Rev off the Jutlandic west coast, the expected annual production is about 21.3 GWh within the wind speed interval of from 4 to 25 m/s. If a cut-out wind speed of 16 m/s is selected instead, the annual production becomes 16.5 GWh corresponding to a loss of energy output of 22.5%. Assuming an average area price of 0.5 DKK/kWh in case of wind speeds below 16 m/s and 0.10 DKK/in case of wind speeds above 16 m/s, the loss in energy production of 22.5% corresponds, however, to a loss of income of only 6%. If a location with a mean wind speed of 8 m/s is concerned instead, corresponding to many locations in Denmark, the loss of income from the turbine is 4% only. Possibly the prices selected for this example are too extreme, but the tendency and conclusions are still valid in case of smaller differences in the prices on current.

The fact that the wind turbine can be stopped already at 16 m/s instead of at 25 m/s can be utilised to optimise the rotor to added production at wind speeds of up to 16 m/s, since the production at wind speeds of up to 16 m/s is to be increased by a mere 4% to reach “break-even”. As mentioned above, this can be accomplished in a simple manner by increasing the swept area by 4% which requires a 2% increase in the blade length corresponding to an increase of from eg 61.5 to 62.7 m. If, from the onset, the entire rotor and wind turbine is optimised for operation exclusively within the wind speed interval of from 4 to eg 16 m/s, the potential is, however, even larger, due to the loads on the wind turbine usually being very large within the wind speed interval of from 16 to 25 m/s.

The below table contains examples of the required increase in the production (in %) at wind speed up to the cut-out wind speed to reach break-even, assuming an original cut-out wind speed of 25 m/s and an average area price of 0.50 DKK/kWh at wind speeds below the selected cut-out wind speed and 0.10 DKK/kWh at wind speeds above the selected cut-out wind speed.

Mean wind speed

| Cut-out wind speed | 7 | 8 | 9 | 10 |
|---|---|---|---|---|
| [m/s] | [m/s] | [m/s] | [m/s] | [m/s] |
| 15 | 3 | 6 | 9 | 12 |
| 16 | 2 | 4 | 6 | 8 |
| 17 | 1 | 2 | 4 | 6 |
| 18 | 1 | 1 | 3 | 4 |

Other types of power curves that cover other embodiments of the invention are outlined in FIG. 6 along with a conventional power curve 201 for comparison. Here, the power curve 601 illustrates a wind power plant that supplies a higher power output at the lower wind speeds, but is power-regulated at the same or even lower maximal power Pₘₐₓ like the first conventional plant and has a lower rated wind speed. Power regulation is thus performed from a lower wind speed. The power curve 602 illustrates a wind power plant that starts to regulate power at the same wind speed (unchanged rated wind speed) like the first conventional plant, but it is designed to achieve higher power outputs until the cut-out wind speed. Finally, the same increased power output at the lower wind speeds can also be obtained by a wind energy plant which is not power-regulated. The power curve of such is shown as 603 in the figure. Then, the wind power plant may be provided with eg a larger rotor and will produce maximal power until it is stopped, just like that, without preceding power regulation. Hereby the advantageous aspect is accomplished that the power regulating means and mechanisms can be omitted, thereby making the wind power plant considerably more simple and inexpensive to manufacture. This will also entail that the wind turbine weighs less, whereby the forces acting on the wind turbine are also considerably reduced. This, in turn, may also entail that the turbine can be stopped at slightly higher wind speeds than would otherwise be the case.

It will be understood that the invention as taught in the present specification and figures can be modified or changed while continuing to be comprised by the scope of protection of the following claims.

1. A group of wind power plants for positioning in approximately the same wind climate comprising:
at least a first and at least a second wind power plant coupled to a same energy network, wherein the first wind power plant exhibits maximized power output within a first interval of wind speeds, and wherein the second wind power plant is designed and constructed to supplement said at least first wind power plant by exhibiting maximized power output within a second interval of wind speeds which is different from and starting from lower wind speeds than the first wind speed interval to the effect that the total power output for the group of wind power plants is increased at lower wind speeds.

2. The group of wind power plants of claim 1, wherein the second wind power plant has a lower cut-out wind speed than the first wind power plant.

3. The group of wind power plants of claim 1, wherein the second wind power plant has greater rotor area than the first wind power plant.

4. The group of wind power plants of claim 1, wherein the second wind power plant has greater solidity than the first wind power plant.

5. The group of wind power plants of claim 1, wherein the second wind power plant does not comprise power regulating means.

6. The group of wind power plants of claim 1, wherein the second wind power plant has a lower rated wind speed than the first wind power plant.

7. A method of designing a group of wind power plants for positioning in approximately the same wind climate, comprising:
providing at least a first and at least a second wind power plant coupled to the same energy network, of which the first wind power plant exhibits maximized power output within a first interval of wind speeds, wherein the second wind power plant is designed to supplement said at least first wind power plant by exhibiting maximized power output within a second interval of wind speeds which is different from and starting from lower wind speeds than the first wind speed interval to the effect that the total power output of the group of wind power plants is increased at lower wind speeds.

8. The method of claim 7, wherein the second wind power plant is designed to exhibit maximized power output within a second interval of wind speeds to the effect that the value of the total power output of the group of wind power plants is maximized.

9. The method of claim 7, wherein the second wind power plant is designed by selection of blade length.

10. The method of claim 7, wherein the second wind power plant is designed by selection of solidity.

11. The method of claim 7, further comprising using the transmission capacity of the group to determine the desired power output of the second wind power plant.

12. The method of claim 7, further comprising using the price on current to determine the desired power output of the second wind power plant.

13-17. (canceled)
